(19) United States
(12) Patent Application Publication
(10) Pub. No.: US 2009/0297737 A1
(43) Pub. Date: Dec. 3, 2009

(54) Glow in the dark artwork and method of fabrication of a nocturnal scene, celestial images, stars, globular star clusters, and three-dimensional planets

(76) Inventor: James Ross Cruz, Roseville, CA (US)

Correspondence Address: James R. Cruz, 1557 Chadbury Drive, Roseville, CA, 95678, US

(21) Appl. No.: 12/454,045

(22) Filed: May 13, 2009

Related U.S. Application Data
(60) Provisional application No. 61/128,831, filed on May 27, 2008.

(51) Int. Cl. B44F 1/00; B44F 7/00; B29C 65/00; B05D 5/06

(52) U.S. Cl. 428/15; 428/29; 427/157; 156/61

(57) ABSTRACT

Black and or, clear acrylic plastic provides a substrate so that particles of phosphorescent material appear as celestial images that glow in the dark. Ambient or ultra-violet light charges the phosphorescent particles providing a realistic depiction of stars, planets, and deep space objects. Three-dimensional representations of planet earth, earth continents, and multi-color planets are also produced with phosphorescent material.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISK APPENDIX

“Not Applicable”

### BACKGROUND OF THE INVENTION

Few activities convey a more enjoyable experience than stargazing. This invention makes accessible a realistic interpretation of a nocturnal scene with celestial images that evoke relaxation, imagination, meditation, and entertainment for the viewer regardless of age or level of understanding. Stargazing is considered an outside activity that offers the greatest enjoyment on a clear night. This invention allows the viewer to enjoy stargazing indoors at any time. Children and adults finds the present art novel, often a sleep aid, evolving to a functional and enjoyable a night-light.

### DESCRIPTION OF PRIOR ART

Stotler et al U.S. Pat. No. 4,955,714 September 1990 is a system of painting interior walls and ceilings with glow-in-the-dark phosphorescent paint. A light source surrounded by a container with calculated perforated apertures is utilized for the placement of light spots on walls and ceilings that resemble the arrangement of known constellations. A workman using then paints the projected light spots with phosphorescent paint. The painted spots glow in the dark after being charged by ambient light, and the room is darkened. However, the financial investment is lost when re-painting is necessary, or desired. Installation of the present art does not require painting of walls or ceilings; thus painting has no affect on the continued use of the present art. The present art is secured by external mounting brackets, or two-sided adhesive tape, thus when painting is necessary the present art is simply removed and reinstalled after painting is completed protecting the original investment. The present art is modular, portable, and expandable.

Wederski et al U.S. Pat. No. 4,568,287 August 1984 describes a light charged celestial device with upper and lower sheets of transparent plastic. Between these sheets the celestial images are applied with luminous paint. After being exposed to ambient light the painted celestial images glow when the room is darkened. This device is hung from the ceiling and viewed overhead from a horizontal position. The device may include an electric motor that turns the device simulating the rotation of the earth. It would appear that the size of this prior art is limited to the weight of the object that can be rotated by a small electric motor. Whereas, the present art is installed with mirror clips or two sided tape and viewed from any position of comfort. Noise and electrical requirements associated with an electric motor are non-existent in the present art.

Smith et al U.S. Pat. No. 5,084,309 January 1992 describes a product and fabrication method for the generation of images that glow-in-the-dark primarily directed to the production of novelty artwork and children's puzzles. Four-color printing is used for the primary image and the second image or glow-in-the-dark image is made of phosphorescent material. The overlaying of the second image phosphorescent material can be accomplished by screen-printing. According to claim, the primary substrate is paper-allowing lamination to a backing panel for cutting into a puzzle. Other substrates include wood, cloth, and leather, ceramic and plastic. Although the fabrication of this prior art is a “glow in the dark” image, this invention does not utilize the fabrication techniques employed in the present art, the product objectives, nor is the target audience restricted to children.

### BRIEF SUMMARY OF THE INVENTION

Black or clear acrylic plastic provides an imaging substrate for the glow in the dark phosphorescent particles. Non-toxic phosphorescent pigments are mixed with water based medium to create and emulate stars, planets, and deep space celestial images. After being charged by ambient or ultra-violet light the celestial images and planets will glow for several hours when the surrounding environment is darkened, usually a room. Imaging existing ceiling tiles extends applications into business offices such as: chiropractic, and massage therapists. In these installations the present art is viewed from a horizontal position as other services are provided. Three-dimensional spheres representing planets can be incorporated in the present art including planet earth with depictions of familiar earth continents. A planet can be permanently bonded to the present art, or suspended from the ceiling in front of the present art. Both alternatives provide a three-dimensional perspective. Craters and planet contours are made of air-dried clay or latex both manually, or from a mold. Craters and contours are applied directly on the surface of the Styrofoam sphere. The sphere is then sealed with white acrylic paint, followed by the application of phosphorescent material.

Dual pane design is also offered combining black and clear acrylic to enhance visual depth perception. The black and clear acrylic substrates overlay each other separated by a clear spacer in each corner. Imaged with phosphorescent materials the black acrylic substrate is a minimum of ½ inch behind the clear substrate. The clear substrate is installed with the imaged phosphorescent side facing the black substrate to provide a smooth cleaning surface. The black substrate can also be imaged with multi-color star clusters, gas clouds, and the clear substrate with stars only, one of many design options.

The present art is completely self-contained, self-installable, portable, and expandability. The fabrication process guarantees that no two designs of the star background will ever be repeated.

### BRIEF DESCRIPTION OF SEVERAL VIEWS OF THE DRAWINGS

FIG. 1 Top view of the acrylic plastic sheet substrate.

FIG. 2 is and end view showing the various star sizes dispersed on the acrylic plastic substrate and clear coating.

FIG. 3 is a cut away side view of a planet showing the Styrofoam sphere and coatings.

FIG. 4 is a top view of a mold with outline of earth continents.

FIG. 5 is a top view of planet earth with continents bonded to Styrofoam sphere.

FIG. 6 a side view of planet earth bonded directly to the acrylic plastic background.

FIG. 7 a side view of planet earth suspended from the ceiling by black thread in front of the acrylic plastic substrate.

FIG. 8 a side view of dual pane design with black and clear substrates separated by clear spacers.

FIG. 9 a side view of clear acrylic substrate imaged with celestial images on both sides

### DETAILED DESCRIPTION OF THE INVENTION

Stars and planets are created with dry phosphorescent pigment mixed with a clear liquid water-based medium. Colors including are: yellow, orange, purple, blue, aqua, red, and green. The ratio of dry phosphorescent pigment to liquid water-based medium is dependant on the color used, application, and will range from 1 part dry phosphorescent pigment to 4 parts clear liquid medium, to 1 part dry pigment to 2 parts clear liquid water-based medium. Maximum glow time is the objective.

After mixing the phosphorescent pigment and water-based medium round spots ranging in size from 1/16″ to ¼″ are imaged on ceramic tile and allowed to dry. The dried luminescent spots are removed and ground sizes approximating: extra fine, fine, medium, course, and very course particles. The round spots are also used in original sizes without sizing.

The arrangement of known constellations can also be designed and imaged using the luminescent spots and sized phosphorescent particles.

Referring to FIG. 1 Sheets of acrylic plastic 10, provides the substrate for imaging with phosphorescent particles and celestial images.

Referring to FIG. 2 Phosphorescent particles emulate small stars 12, medium stars 14, large stars 16, are dispersed on the acrylic substrate 10. A low-pressure pulsing spray of clear paint 18, is applied and allowed to dry to a tack holding the particles in place. The present art is then brought to a vertical position to complete the spray-painting process. Please note that items 12,14, and 16, are shown as only one image each to show differences in relative size. In reality, there are several hundred of each particle size to provide perspective and depth of field. The acrylic substrate is also imaged directly on the surface with droplets of liquid phosphorescent material, especially at the edges. This provides continuity of image when multiple platforms are butted together to extend the size of the present art.

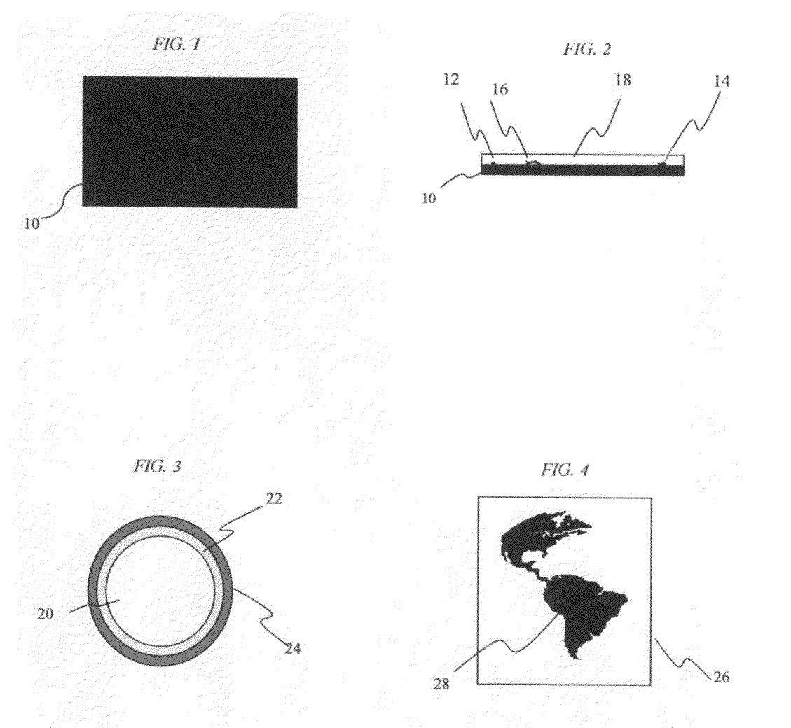

Referring to FIG. 3. A Styrofoam sphere 20, is sanded smooth and several coats of white acrylic paint 22, is applied. White acrylic paint is applied to seal the Styrofoam and enhance brightness extending the glow time of the phosphorescent material. A color is selected and the planet is painted with liquid phosphorescent material 24. Other sizes of planets are created using the same procedure and process.

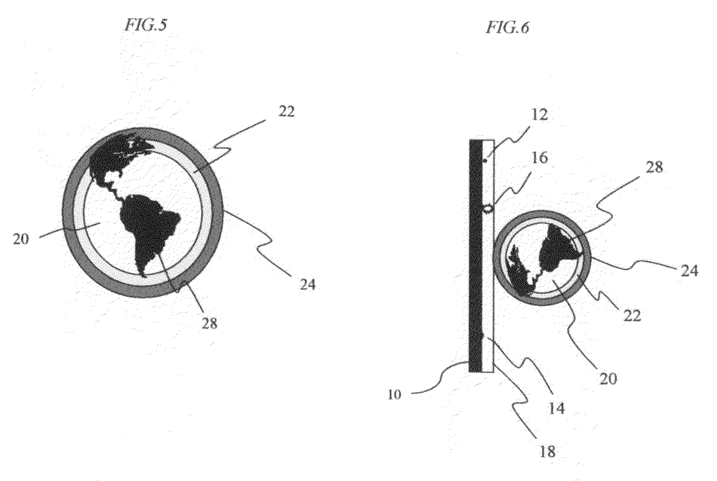

Referring to FIG. 4. The outline of familiar earth continents 28, is recessed in mold 26, approximately 1/16 of an inch. Phosphorescent material is poured into the continent outline and allowed to dry.

Referring to FIG. 5. The phosphorescent replica of the continent 28, is removed from the mold, positioned, and bonded to the planet.

Referring to FIG. 6. The finished replica of the planet is ground flat on the backside and bonded to the surface of the acrylic substrate.

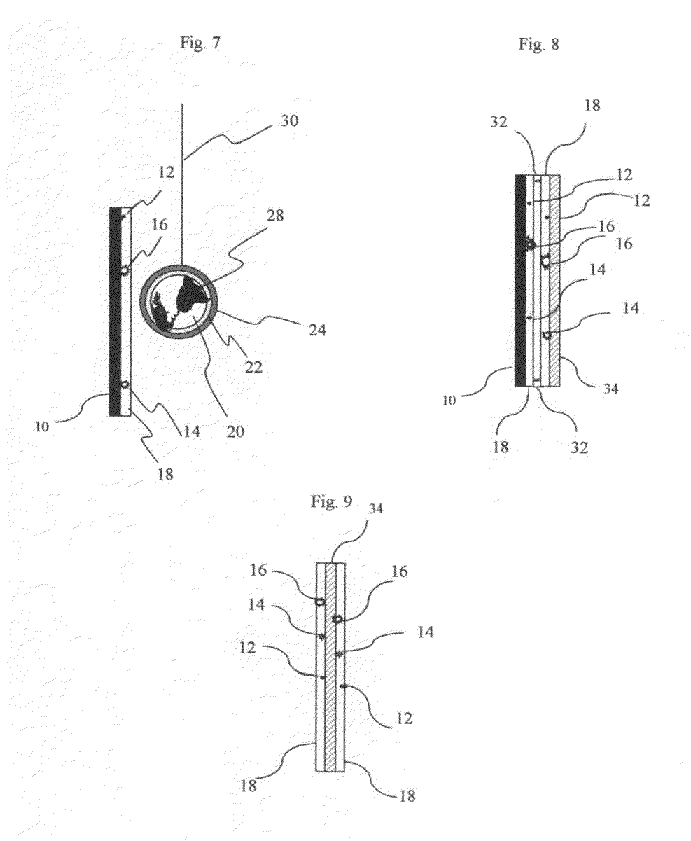

Referring to FIG. 7. Black thread 30, suspends the planet from the ceiling in front of the imaged substrate, or a location of choice.

Referring to FIG. 8. Both the black and clear acrylic substrate is imaged with phosphorescent material as previously described in referring to FIG.2. The imaged side of the clear acrylic substrate 34, is placed facing the imaged side of the black substrate 10, separated by clear spacers 32, a minimum of ½ inch in each corner. This positioning provides a smooth cleaning surface.

Referring to FIG. 9. Clear acrylic substrate 34, is imaged with phosphorescent material on both sides of the substrate. Small stars 12, medium stars 14, large stars 16, are dispersed on the acrylic substrate and sprayed with clear paint 18, and allowed to dry. The reverse side of the substrate is imaged small stars 12, medium stars 14, large stars 16, are dispersed on the clear acrylic substrate 34, gas clouds are imaged manually. The substrate is then sprayed with clear spray paint 18, and allowed to dry. The nocturnal background is the darkness of the installation wall, or substrate can be suspended from a ceiling providing a free-floating effect.

1. Black and clear sheets of acrylic plastic and other substrates provide a night background contrasted by phosphorescent particles that emulate stars, star clusters, globular star clusters, deep space objects, glow in the dark after being charged by ambient or ultraviolet light.

2. According to claim 1 other substrates include: plastics, ceramic tile, composition ceiling tiles, magnetic tape, vinyl, and Styrofoam, canvas.

3. According to claim 1 phosphorescent particles and images are bonded to the substrate with clear acrylic spray paint.

4. According to claim 1 present art is night-light.

5. According to claim 1 the placement of phosphorescent particles that emulate stars, star clusters, globular star clusters, and deep space objects is unique and will never be repeated.

6. According to claim 1 present art is portable and expandable.

7. According to claim 1 dual pane product are comprised of black and clear acrylic plastic separated by spacers.

8. According to claim 1 both sides of a clear acrylic substrate are imaged with phosphorescent particles.

9. Three-dimensional planets are created from Styrofoam spheres coated with phosphorescent compositions.

10. According to claim 9 planets are bonded to the surface of the background, or suspended from the ceiling in front of the background.
